(19) United States
(12) Patent Application Publication
(10) Pub. No.: US 2025/0132372 A1
(43) Pub. Date: Apr. 24, 2025

(54) CELL AND PRISMATIC BATTERY

(71) Applicants: Microvast Power Systems Co., Ltd., Huzhou (CN); Microvast, Inc., Stafford, TX (US)

(72) Inventors: Guoyou DENG, Huzhou (CN); Xiaojie SHEN, Huzhou (CN); Chao LI, Huzhou (CN); Caihui SHI, Huzhou (CN); Xiaohe LI, Huzhou (CN)

(73) Assignees: Microvast Power Systems Co., Ltd., Huzhou, ZJ (CN); Microvast, Inc., Stafford, TX (CN)

(21) Appl. No.: 18/679,477

(22) Filed: May 31, 2024

(30) Foreign Application Priority Data
Oct. 24, 2023 (CN) 202322871913.8

(51) Int. Cl. H01M 10/04; H01M 10/6555; H01M 50/103

(52) U.S. Cl. CPC H01M 10/0431; H01M 10/6555; H01M 50/103

(57) ABSTRACT

A cell is provided, including a main body formed by winding electrode sheets and a separator. The main body is a flat structure with a length direction and a width direction. The first length L1 of the main body along the length direction is greater than the first width W1 of the main body along the width direction. The width direction of the main body is perpendicular to the plane where the winding direction of the main body is located. The cell has a width direction perpendicular to the plane where the winding direction of the main body is located, thereby shortening the infiltration path of the electrolyte and improving the infiltration rate and infiltration effect of the electrolyte. A prismatic battery is also provided.

### TECHNICAL FIELD

The present application relates to the technical field of battery technology, and in particular, to a cell and a prismatic battery.

### BACKGROUND

A prismatic battery includes a case and a cell disposed inside the case. The cell is generally divided into two types: laminated cells and wound cells. Specifically, the wound cell has a flat structure, which is generally formed by stacking and winding the electrode sheets and the separator to form a hollow cylindrical structure followed by flattening (the specific structure can refer to patent publication No. CN206322807U, etc.).

During electrolyte injection into a prismatic battery, when the cell is a flat wound cell, the electrolyte needs to enter the cell in a direction perpendicular to the winding direction of the cell (that is, the electrolyte enters the cell from the end face of the cell) due to the obstruction of the separator and the electrode sheets, in order to soak the cell. However, when the winding direction of the cell is perpendicular to its length direction, that is, the end faces of the cell are located at two ends of its length direction, the electrolyte needs to enter the cell along its length direction, making the infiltration path of the electrolyte longer, such that it is difficult for the electrolyte to enter the interior of the cell, thereby affecting the infiltration rate and infiltration effect of the electrolyte.

### SUMMARY

The object of the present application is to provide a cell, with the width direction of the main body being perpendicular to the plane where the winding direction of the main body is located, thereby shortening the infiltration path of the electrolyte, and improving the infiltration rate and infiltration effect of the electrolyte.

In a first aspect, the present application provides a cell which includes a main body formed by winding electrode sheets and a separator. The main body is a flat structure with a length direction and a width direction. The first length L1 of the main body along the length direction is greater than the first width W1 of the main body along the width direction. The width direction of the main body is perpendicular to the plane where the winding direction of the main body is located, and the end faces of the main body are located at two ends of the main body along the width direction.

In an achievable manner, the first length L1 is not less than 300 mm. When the first length L1 is greater than or equal to 300 mm, this embodiment has a more significant improvement in the infiltration efficiency of the cell. In an achievable manner, the first length L1 is not less than 500 mm; alternatively, the first length L1 is not less than 700 mm.

In an achievable manner, the first length L1 and the first width W1 meet the requirement: 1<L1/W1≤15.

In an achievable manner, the main body further has a thickness direction, and the first thickness D1 of the main body along the thickness direction and the first width W1 meet the requirement: 1<W1/D1≤50.

In an achievable manner, the electrode sheets include a positive electrode sheet and a negative electrode sheet, and the main body is formed by winding the positive electrode sheet, the negative electrode sheet and the separator; the positive electrode sheet is provided with a positive tab, and the negative electrode sheet is provided with a negative tab, wherein both the positive tab and the negative tab are located at one end of the main body along the width direction.

In an achievable manner, the positive tab and the negative tab are located at the same end of the main body along the width direction, and the positive tab and the negative tab are spaced from each other in the length direction of the main body.

In an achievable manner, the positive electrode sheet is provided with multiple positive tabs that are spaced from each other, the multiple positive tabs are located on the same side of the positive electrode sheet along the width direction, and the multiple positive tabs are stacked along the thickness direction of the main body to form a positive tab group; the negative electrode sheet is provided with multiple negative tabs that are spaced from each other, the multiple negative tabs are located on the same side of the negative electrode sheet along the width direction, and the multiple negative tabs are stacked along the thickness direction of the main body to form a negative tab group.

In an achievable manner, the positive tab group and the negative tab group are located at the same end of the main body along the width direction, and the positive tab group and the negative tab group are spaced from each other in the length direction of the main body.

In an achievable manner, along the length direction of the main body, the positive tab group has a second length L2, and the negative tab group has a third length L3;

the second length L2 and the first length L1 meet the requirement:

$$\frac{1}{20} L 1 \leq L 2 < \frac{1}{2} L 1 ;$$

the third length L3 and the first length L1 meet the requirement:

$$\frac{1}{20} L 1 \leq L 3 < \frac{1}{2} L 1.$$

In an achievable manner, the number of winding turns of the positive electrode sheet is a1, and the number of the positive tabs being stacked in the positive tab group is a2, then it is satisfied: 0.1a1≤a2≤2a1;

the number of winding turns of the negative electrode sheet is b1, and the number of the negative tabs being stacked in the negative tab group is b2, then it is satisfied: 0.1b1≤b2≤2b1.

In an achievable manner, each winding turn of the positive electrode sheet is provided with one positive tab, and each winding turn of the negative electrode sheet is provided with one negative tab; along the thickness direction of the main body, multiple positive tabs are located on the same side of multiple winding turns of the positive electrode sheet, and multiple negative tabs are located on the same side of multiple winding turns of the negative electrode sheet.

In an achievable manner, each winding turn of the positive electrode sheet is provided with two positive tabs, and the two positive tabs on each winding turn of the positive electrode sheet are arranged along the thickness direction of the main body; each winding turn of the negative electrode sheet is provided with two negative tabs, and the two negative tabs on each winding turn of the negative electrode sheet are arranged along the thickness direction of the main body.

In a second aspect, the present application provides a prismatic battery, including a case and a cell, wherein the cell is disposed inside the case.

In an achievable manner, multiple cells are disposed inside the case, and the multiple cells are arranged along the thickness direction of the main body; the prismatic battery further includes a heat conduction member, and the heat conduction member is disposed inside the case, the heat conduction member includes a clamping part and a contact part which are connected to each other, wherein the clamping part is clamped between adjacent cells, and the contact part is in contact with an inner wall of the case.

In an achievable manner, the prismatic battery further includes a cover plate and a connecting plate; along the length direction of the main body, at least one end of the case is provided with an opening, and the cover plate is disposed at the opening; the connecting plate is disposed inside the case, and the cover plate is provided with a pole;

the electrode sheets include a positive electrode sheet and a negative electrode sheet, and the main body is formed by winding the positive electrode sheet, the negative electrode sheet and the separator; the positive electrode sheet is provided with multiple positive tabs, and the multiple positive tabs are stacked to form a positive tab group; the negative electrode sheet is provided with multiple negative tabs, and the multiple negative tabs are stacked to form a negative tab group; one of the positive tab group and the negative tab group on the cell is electrically connected to the pole through the connecting plate, and the other of the positive tab group and the negative tab group is electrically connected to the case; or, the positive tab group and the negative tab group on the cell are each electrically connected to the pole of a corresponding connecting plate.

In an achievable manner, multiple cells are disposed inside the case, and the multiple cells are arranged along the thickness direction of the main body; the positive tab groups of the multiple cells are respectively connected to multiple connecting plates, and/or the negative tab groups of the multiple cells are respectively connected to multiple connecting plates;
or, in the multiple cells, the positive tab groups of at least some of the cells are connected to the same connecting plate, and/or the negative tab groups of at least some of the cells are connected to the same connecting plate.

The cell provided in the present application has a width direction of the main body perpendicular to the plane where the winding direction of the main body is located, that is, the end faces of the main body are located at two ends of the main body along the width direction. Therefore, the electrolyte can enter the interior of the cell from the end faces at the two ends of the main body, that is, the electrolyte can enter the interior of the cell along the width direction of the main body, thereby shortening the infiltration path of the electrolyte and improving the infiltration rate and infiltration effect of the electrolyte.

### BRIEF DESCRIPTION OF THE DRAWINGS

FIG. 1 is a front view of the cell in the embodiment of the present application after removing the insulation layer.

FIG. 2 is a top view of FIG. 1.

FIG. 3 is a schematic diagram of the structure of the positive electrode sheet in the embodiment of the present application.

FIG. 4 is a schematic diagram of the structure of the negative electrode sheet in the embodiment of the present application.

FIG. 5 is a schematic diagram of the cell during the production process in the embodiment of the present application.

FIG. 6 is a schematic diagram of the cell during the production process in another embodiment of the present application.

FIG. 7 is a schematic diagram of the cell during the production process in another embodiment of the present application.

FIG. 8 is a schematic diagram of the cell during the production process in another embodiment of the present application.

FIG. 9 is a schematic diagram of the cell during the production process in another embodiment of the present application.

FIG. 10 is a schematic diagram of the three-dimensional structure of the prismatic battery in the embodiment of the present application.

FIG. 11 is a schematic diagram of the explosive structure of FIG. 10.

FIG. 12 is a schematic diagram of the three-dimensional connection structure between the connecting plate and the cell in the embodiment of the present application.

FIG. 13 is a side view of FIG. 12.

FIG. 14 is a schematic diagram of the three-dimensional connection structure between the connecting plate and the cell in another embodiment of the present application.

FIG. 15 is a side view of the connection structure between the connecting plate and the cell in another embodiment of the present application.

FIGS. 16a to 16c are schematic diagrams of the assembly process between the connecting plate and the cell in an embodiment of the present application.

FIGS. 17a and 17b are schematic diagrams of the assembly process between the connecting plate and the cell in another embodiment of the present application.

In the figures: 1—cell, 100—hollow cylinder, 11—main body, 110—end face, 111—starting winding layer, 112—first part, 113—second part, 12—positive electrode sheet, 121—positive tab, 13—negative electrode sheet, 131—negative tab, 14—positive tab group, 15—negative tab group, 16—insulation layer, 2—case, 21—opening, 3—cover plate, 31—pole, 4—heat conduction member, 41—clamping part, 42—contact part, 5—connecting plate, 6—insulation sheet, 7—insulation film.

### DETAILED DESCRIPTION OF THE EMBODIMENTS

The following will provide a further detailed description of the specific implementations of the present application in conjunction with the accompanying drawings and embodiments. The following embodiments are used to illustrate the present application, but are not intended to limit the scope of the present application.

The terms “first”, “second”, “third”, “fourth”, etc. (if any) in the specification and claims of the present application are only used to distinguish similar objects, and are not intended to be used to describe a specific sequence or order.

The terms “up”, “down”, “left”, “right”, “front”, “back”, “top”, “bottom” (if any) in the specification and claims of the present application are defined based on the position of the structure in the figures and the position between the structures in the figures, only for the clarity and convenience of expressing the technical solution. It should be understood that the use of these directional words should not limit the scope of protection in the present application.

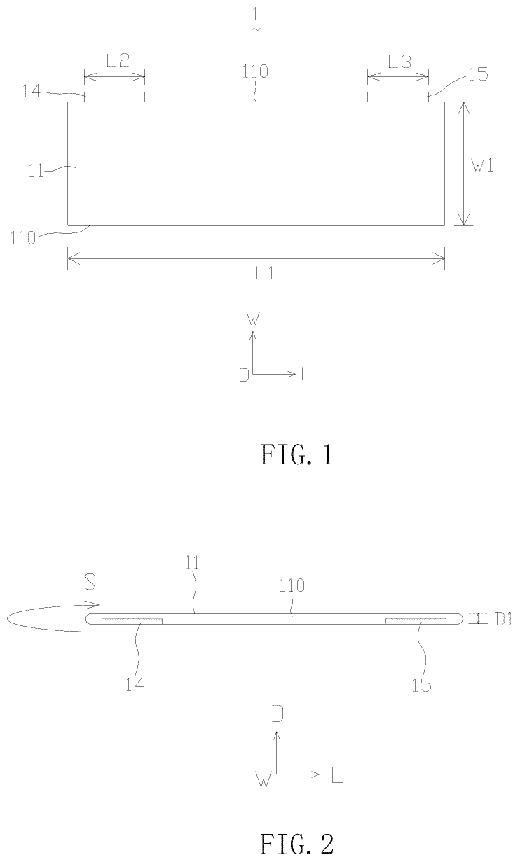

As shown in FIGS. 1 and 2, the cell 1 provided in the embodiment of the present application includes a main body 11 formed by winding the electrode sheets and the separator (not shown) after they are stacked. The main body 11 has a flat structure with a length direction L and a width direction W. The first length L1 of the main body 11 along the length direction L is greater than the first width W1 of the main body 11 along the width direction W. The width direction W of the main body 11 is perpendicular to the plane where the winding direction S (i.e., the winding direction of the electrode sheets and the separator) of the main body 11 is located. The end faces 110 of the main body 11 are located at two ends of the main body 11 along the width direction W, and the electrolyte can enter the cell 1 from the end faces 110 at the two ends of the main body 11.

In an achievable manner, the first length L1 is not less than 300 mm. When the first length L1 is greater than or equal to 300 mm, this embodiment has a more significant improvement in the infiltration efficiency of the cell 1. In an achievable manner, the first length L1 is not less than 500 mm; alternatively, the first length L1 is not less than 700 mm.

Specifically, in the cell 1 provided in this embodiment, the width direction W of the main body 11 is perpendicular to the plane where the winding direction S of the main body 11 is located, that is, the end faces 110 of the main body 11 are located at two ends of the main body 11 along the width direction W. Therefore, the electrolyte can enter the interior of the cell 1 from the end faces 110 of the main body 11, that is, the electrolyte can enter the interior of the cell 1 along the width direction W of the main body 11, thereby shortening the infiltration path of the electrolyte and improving the infiltration rate and infiltration effect of the electrolyte.

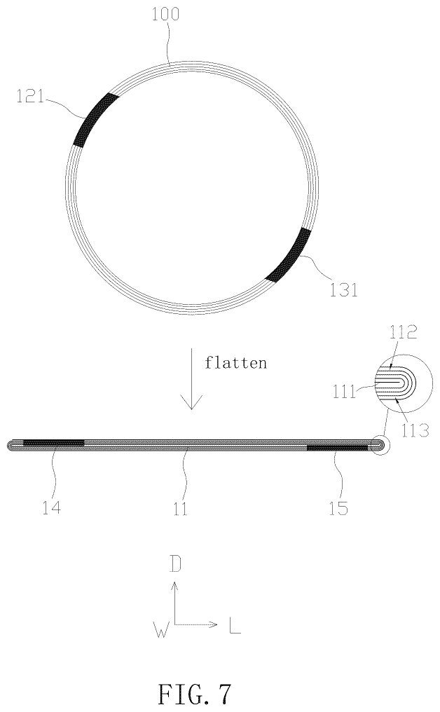

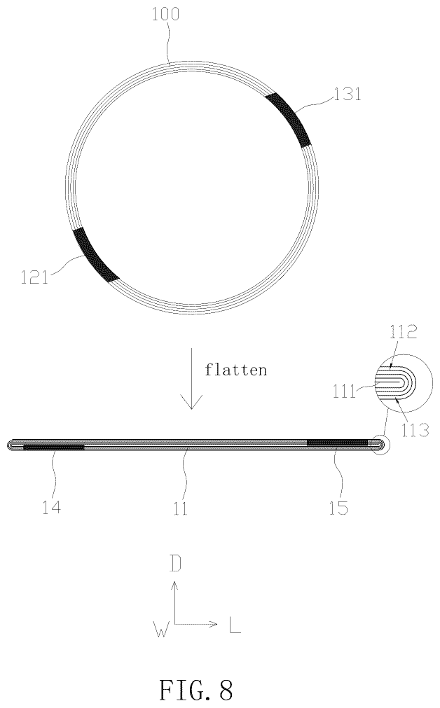

As shown in FIG. 1, as an embodiment, the first length L1 and the first width W1 meet the requirement: 1<L1/W1≤15. Therefore, for a given area of the cell 1 along the length and the width, the cell 1 is avoided from being too long, thereby avoiding the problem of the case 2 (the specific structure of the case 2 can refer to FIGS. 7 and 8) containing the cell 1 being too long and prone to deformation.

As shown in FIG. 1, as an embodiment, the first length L1 and the first width W1 meet the requirement: 2<L1/W1≤6.

As shown in FIGS. 1 and 2, as an embodiment, the main body 11 further has a thickness direction D. The first thickness D1 of the main body 11 along the thickness direction D and the first width W1 meet the requirement: 1<W1/D1≤50.

As shown in FIGS. 1 and 2, as an embodiment, the first thickness D1 and the first width W1 meet the requirement: 5<W1/D1≤25.

As shown in FIGS. 1 to 4, as an embodiment, the electrode sheets include a positive electrode sheet 12 and a negative electrode sheet 13. The main body 11 is formed by winding the positive electrode sheet 12, the negative electrode sheet 13 and the separator after they are stacked. The positive electrode sheet 12 is provided with a positive tab 121, and the negative electrode sheet 13 is provided with a negative tab 131. After winding, both the positive tab 121 and the negative tab 131 are located at one end of the main body 11 along the width direction W.

As shown in FIGS. 1 to 4, as an embodiment, the positive tab 121 and the negative tab 131 are located at the same end of the main body 11 along the width direction W, and the positive tab 121 and the negative tab 131 are spaced from each other in the length direction L of the main body 11. Compared to setting the tabs on two ends of the main body 11 along the width direction W, this method is beneficial for reducing the impact of the tabs on the size of the cell 1 in the width direction W, and for reducing the external size of the cell 1.

As shown in FIGS. 1 to 4, as an embodiment, the positive electrode sheet 12 is provided with multiple positive tabs 121 that are spaced from each other, and the multiple positive tabs 121 are located on the same side of the positive electrode sheet 12 along the width direction W. After winding the positive electrode sheet 12, the multiple positive tabs 121 are stacked along the thickness direction D to form a positive tab group 14. The negative electrode sheet 13 is provided with multiple negative tabs 131 that are spaced from each other, and the multiple negative tabs 131 are located on the same side of the negative electrode sheet 13 along the width direction W. After winding the negative electrode sheet 13, the multiple negative tabs 131 are stacked along the thickness direction D to form a negative tab group 15.

As shown in FIGS. 1 and 2, as an embodiment, the positive tab group 14 and the negative tab group 15 are located at the same end of the main body 11 along the width direction W, and the positive tab group 14 and the negative tab group 15 are spaced from each other in the length direction L of the main body 11.

As shown in FIGS. 1 and 2, as an embodiment, along the length direction L of the main body 11, the positive tab group 14 has a second length L2, and the negative tab group 15 has a third length L3.

The second length L2 and the first length L1 meet the requirement:

$$\frac{1}{20} L 1 \leq L 2 < \frac{1}{2} L 1.$$

The third length L3 and the first length L1 meet the requirement:

$$\frac{1}{20} L 1 \leq L 3 < \frac{1}{2} L 1.$$

Therefore, along the length direction L of the main body 11, the positive tab group 14 or the negative tab group 15 is avoided from being too long to affect the infiltration efficiency of the electrolyte, and meanwhile, the positive tab group 14 or the negative tab group 15 is avoided from being too short to affect the overcurrent performance.

As shown in FIGS. 1 and 2, as an embodiment, the second length L2 and the first length L1 meet the requirement:

$$0.1 L 1 \leq L 2 < \frac{1}{3} L 1.$$

The third length L3 and the first length L1 meet the requirement:

$$0.1 L 1 \leq L 3 < \frac{1}{3} L 1.$$

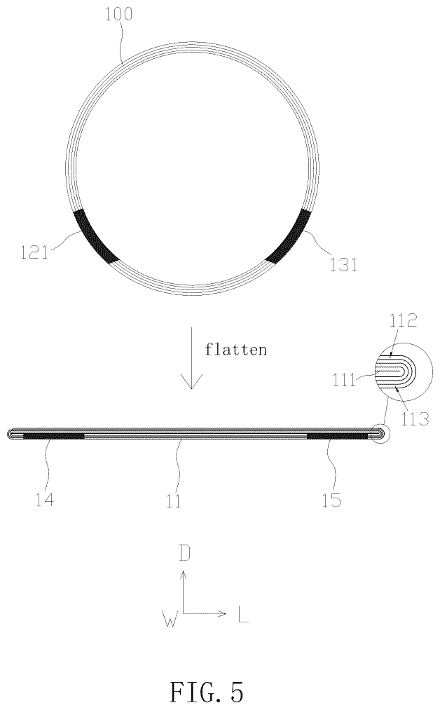

As shown in FIGS. 2 to 5, as an embodiment, the main body 11 is formed by winding the positive electrode sheet 12, the negative electrode sheet 13 and the separator into a hollow cylinder 100 shown in FIG. 5 and then flattening it. The wall thickness of the hollow cylinder 100 is ½ of the first thickness D1.

As an embodiment, the number of winding turns of the positive electrode sheet 12 is a1, and the number of the positive tabs 121 being stacked in the positive tab group 14 is a2, then it is satisfied: 0.1a1≤a2≤2a1 (that is, at least one positive tab 121 is set on every 10 winding turns of the positive electrode sheet 12, and at most two positive tabs 121 are set on each winding turn of the positive electrode sheet 12).

The number of winding turns of the negative electrode sheet 13 is b1, and the number of the negative tabs 131 being stacked in the negative tab group 15 is b2, then it is satisfied: 0.1b1≤b2≤2b1 (that is, at least one negative tab 131 is set on every 10 winding turns of the negative electrode sheet 13, and at most two negative tabs 131 are set on each winding turn of the negative electrode sheet 13).

As shown in FIGS. 2 to 5, as an embodiment, each winding turn of the positive electrode sheet 12 is provided with a positive tab 121, and each winding turn of the negative electrode sheet 13 is provided with a negative tab 131. Along the thickness direction D of the main body 11, multiple positive tabs 121 are located on the same side of multiple winding turns of the positive electrode sheet 12, and multiple negative tabs 131 are located on the same side of multiple winding turns of the negative electrode sheet 13. In other words, along the thickness direction D of the main body 11, the main body 11 is divided into a first part 112 and a second part 113 with the starting winding layer 111 located on the innermost side of the main body 11 as the boundary, wherein the starting winding layer 111 is the layer that starts winding after the positive electrode sheet 12, the negative electrode sheet 13 and the separator are stacked. The thickness of the first part 112 and the second part 113 is the same or similar, that is, along the thickness direction D, the starting winding layer 111 divides the main body 11 into two halves which have the same or similar thickness. The multiple positive tabs 121 are connected to the first part 112 or the second part 113, and the multiple negative tabs 131 are connected to the first part 112 or the second part 113. The starting winding layer 111 can be provided with the positive tab 121 and/or negative tab 131, or no positive tab 121 and/or negative tab 131 is provided on the starting winding layer 111. The multiple positive tabs 121 are located in the same half of the main body 11, and the positive tab group 14 is connected to one half of the main body 11. The multiple negative tabs 131 are located in the same half of the main body 11, and the negative tab group 15 is connected to one half of the main body 11.

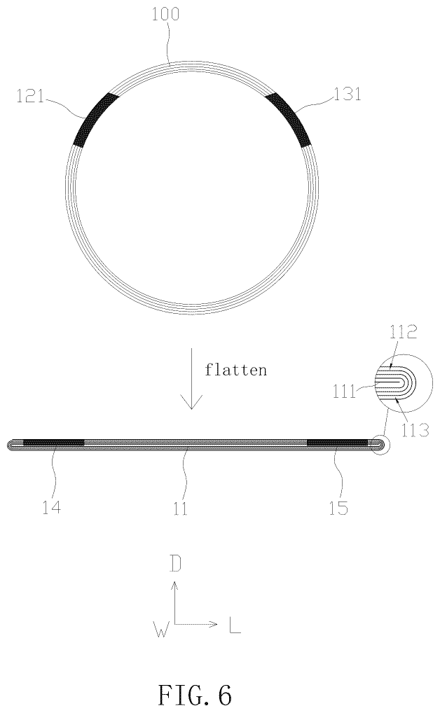

As an embodiment, the multiple positive tabs 121 and the multiple negative tabs 131 are all connected to the first part 112 (as shown in FIG. 6); alternatively, the multiple positive tabs 121 and the multiple negative tabs 131 are all connected to the second part 113 (as shown in FIG. 5), that is, both the positive tab group 14 and the negative tab group 15 are connected to the same half of the main body 11. Alternatively, the multiple positive tabs 121 are all connected to the first part 112, and the multiple negative tabs 131 are all connected to the second part 113 (as shown in FIG. 7); alternatively, the multiple positive tabs 121 are all connected to the second part 113, and the multiple negative tabs 131 are all connected to the first part 112 (as shown in FIG. 8), that is, the positive tab group 14 and the negative tab group 15 are respectively connected to the two halves of the main body 11. The positive electrode sheet 12 or the negative electrode sheet 13 is provided with one tab per winding turn, thereby saving costs in situations with low overcurrent requirements and facilitating the subsequent bending and installation of the tab groups.

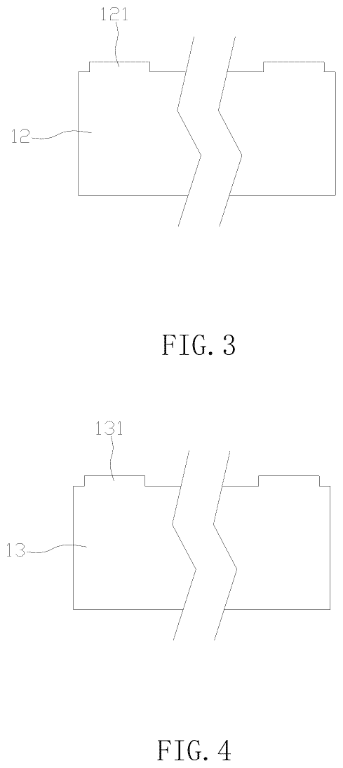

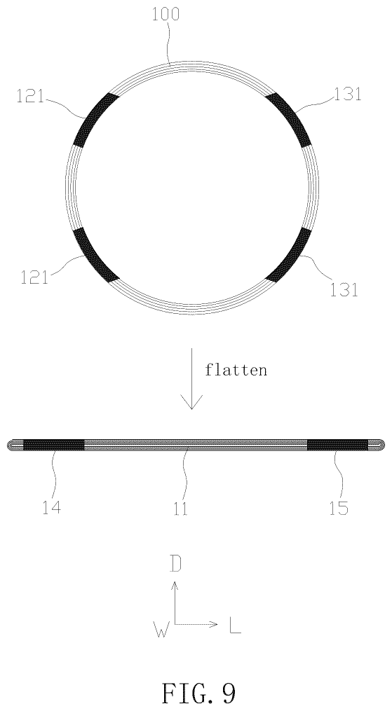

As shown in FIGS. 3, 4, and 9, as another embodiment, each winding turn of the positive electrode sheet 12 is provided with two positive tabs 121, and the two positive tabs 121 on each winding turn of the positive electrode sheet 12 are arranged along the thickness direction D of the main body 11; each winding turn of the negative electrode sheet 13 is provided with two negative tabs 131, and the two negative tabs 131 on each winding turn of the negative electrode sheet 13 are arranged along the thickness direction D of the main body 11. Thus, compared to the above structure of setting only one tab on each winding turn, this structure increases the number of tabs without increasing the number of tab groups, improves the overcurrent capacity of the tab groups, and does not increase the welding frequency of the tab groups.

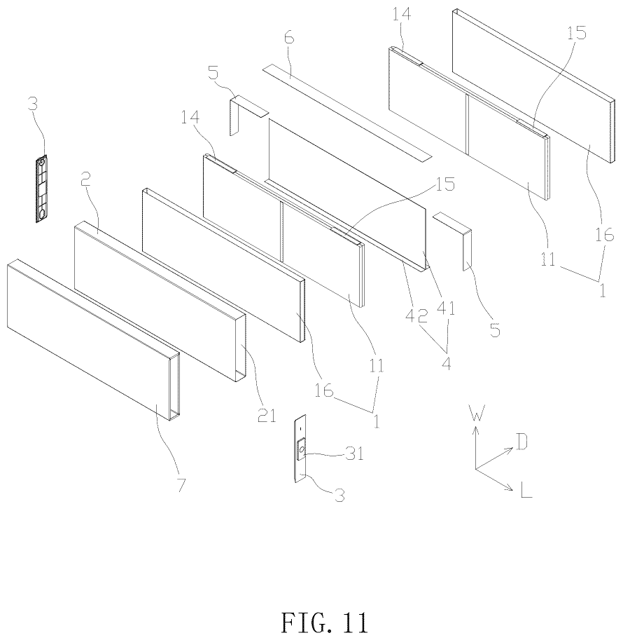

As shown in FIG. 11, as an embodiment, the cell 1 further includes an insulation layer 16, and the insulation layer 16 is wrapped on the outer surface of the main body 11.

As shown in FIGS. 1, 10, and 11, this embodiment further provides a prismatic battery, which includes a square case 2, a cover plate 3, and the cell 1 mentioned above. The cell 1 is disposed inside the case 2. Along the length direction L of the main body 11, at least one end of the case 2 is provided with an opening 21, and the cover plate 3 is disposed at the opening 21 and seals the opening 21.

The shape of the case 2 is determined based on the size of the cell 1, and the length direction of the case 2 is parallel to the length direction L of the main body 11. In this embodiment, since the opening 21 on the case 2 is provided at the end in its length direction, compared to the method of setting the opening at the end in its width direction, the opening 21 is smaller, and the opening 21 is less prone to deformation, which is conducive to the installation of the cover plate 3. An insulation pad is installed on the side of the cover plate 3 away from the cell 1.

As shown in FIGS. 11 and 13, as an embodiment, multiple cells 1 are disposed inside the case 2, and the multiple cells 1 are arranged along the thickness direction D of the main body 11. The prismatic battery further includes a heat conduction member 4, and the heat conduction member 4 is disposed inside the case 2. The heat conduction member 4 includes a clamping part 41 and a contact part 42 which are connected to each other. The clamping part 41 is clamped between adjacent cells 1, and the contact part 42 is in contact with the inner wall of the case 2. Therefore, the heat conduction member 4 can transfer the heat between adjacent cells 1 to the case 2 for heat dissipation.

As an embodiment, both the heat conduction member 4 and the case 2 are made of thermal conductive materials.

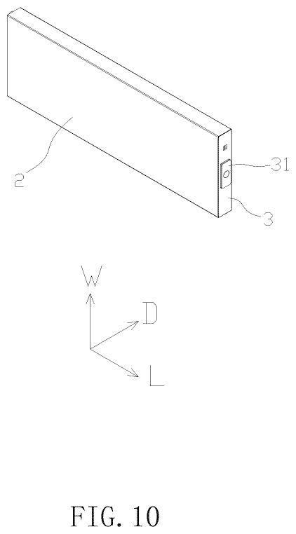

As shown in FIGS. 10 and 11, as an embodiment, the prismatic battery further includes a connecting plate 5, and the connecting plate 5 is disposed inside the case 2. The cover plate 3 is provided with a pole 31, and the positive tab group 14 and the negative tab group 15 on the cell 1 are each electrically connected to the pole 31 of a corresponding connecting plate 5.

Specifically, in this embodiment, along the length direction L of the main body 11, there are openings 21 at two opposite ends of the case 2, and the cover plate 3 is provided at each of the openings 21 at the two opposite ends of the case 2. The cover plates 3 at the two opposite ends of the case 2 are each provided a pole 31, with the pole 31 on one cover plate 3 being a positive pole and the pole 31 on the other cover plate 3 being a negative pole. The positive tab group 14 of the cell 1 is electrically connected to the positive pole through a connecting plate 5, while the negative tab group 15 of the cell 1 is electrically connected to the negative pole through another connecting plate 5. However, in other embodiments, the positive pole and the negative pole can also be simultaneously provided on one cover plate 3, and the positive tab group 14 and the negative tab group 15 of the cell 1 are electrically connected to the positive pole and the negative pole through the connecting plates 5, respectively.

As another implementation, when the case 2 serves as the positive electrode or the negative electrode of the prismatic battery, one of the positive tab group 14 and the negative tab group 15 on the cell 1 is electrically connected to the pole 31 through a connecting plate 5, while the other of the positive tab group 14 and the negative tab group 15 is electrically connected to the case 2 (can be electrically connected to the case 2 by direct contact, or electrically connected to the case 2 through a connecting plate 5).

As an embodiment, the connecting plate 5 is connected to the positive tab group 14 and/or the negative tab group 15 of the cell 1 by welding.

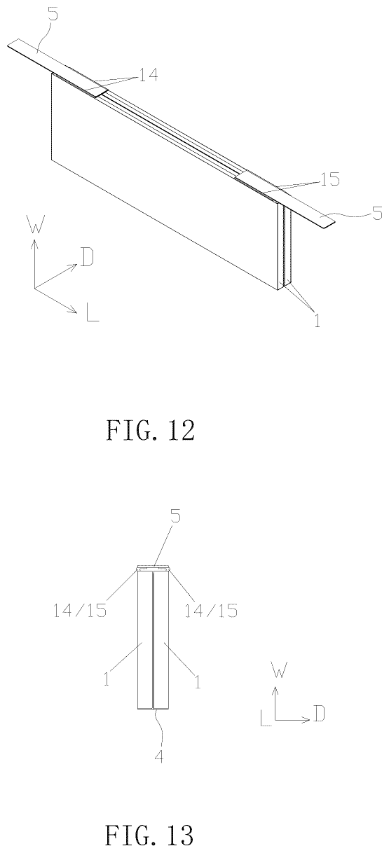

As shown in FIGS. 11 to 13, as an embodiment, multiple cells 1 are disposed inside the case 2, and the multiple cells 1 are arranged along the thickness direction D of the main body 11. In the multiple cells 1, the positive tab groups 14 of at least some of the cells 1 are connected to the same connecting plate 5, and/or, the negative tab groups 15 of at least some of the cell 1 are connected to the same connecting plate 5. In this embodiment, the positive tab groups 14 of all the cells 1 are connected to the same connecting plate 5, and the negative tab groups 15 of all the cells 1 are connected to the same connecting plate 5. The cells 1 in this embodiment are illustrated as two, but in fact, it can be more. It should be noted that the connecting plate 5 in FIGS. 12 and 13 is in a state where it has not been bent after being welded to the positive tab group 14 or the negative tab group 15 of the cell 1 (the connecting plate 5 needs to be bent in order to be electrically connected to the pole 31 of the cover plate 3).

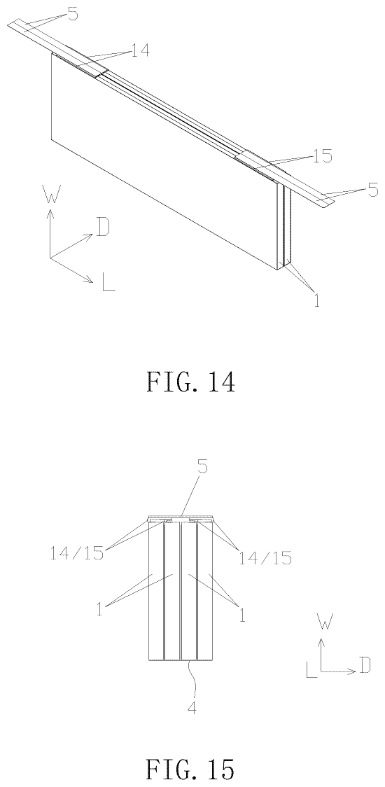

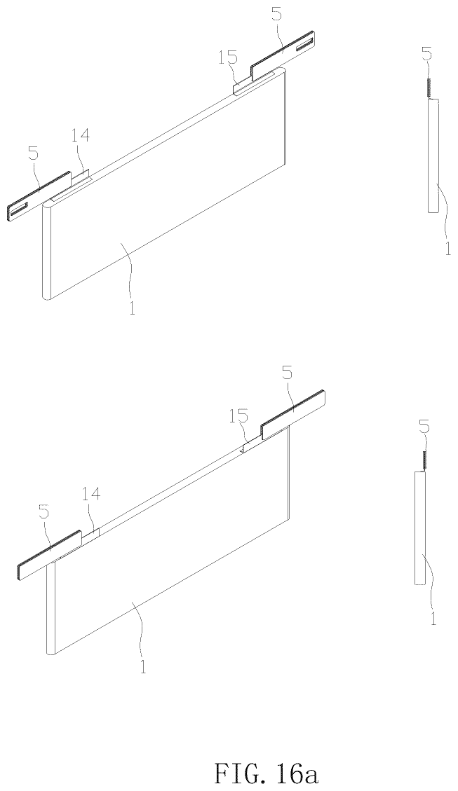

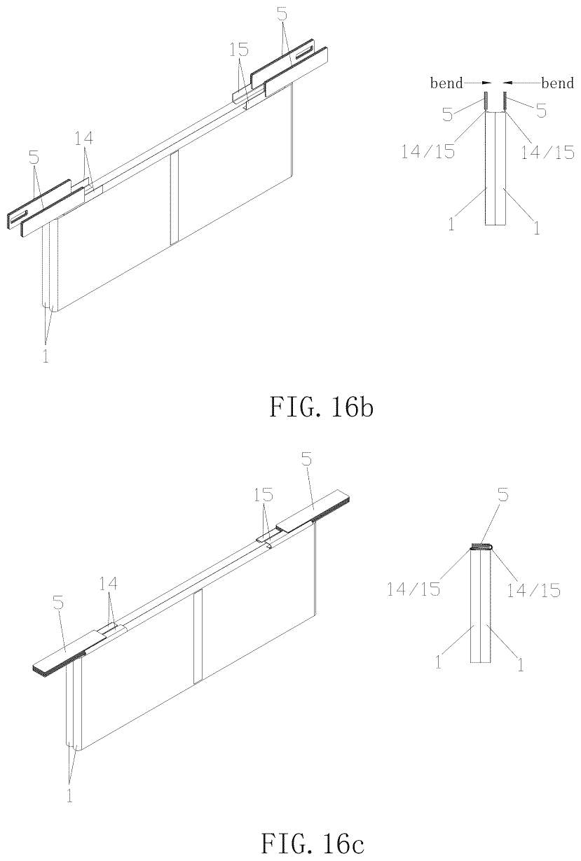

As shown in FIG. 14 and FIGS. 16a to 16c, as another embodiment, in the multiple cells 1, the positive tab groups 14 of the multiple cells 1 are respectively connected to multiple connecting plates 5, and/or the negative tab groups 15 of the multiple cells 1 are respectively connected to multiple connecting plates 5. Specifically, as shown in FIG. 14, the connecting plates 5 connected to the positive tab groups 14 are arranged side by side in the thickness direction D, and the connecting plates 5 connected to the negative tab groups 15 are arranged side by side in the thickness direction D. Alternatively, as shown in FIG. 16c, the connecting plates 5 connected to the positive tab groups 14 are stacked from top to bottom along the thickness direction of the connecting plates 5, and the connecting plates 5 connected to the negative tab groups 15 are stacked from top to bottom along the thickness direction of the connecting plates 5.

As shown in FIGS. 2, 5, and 13, as an embodiment, each winding turn of the positive electrode sheet 12 is provided with a positive tab 121, and each winding turn of the negative electrode sheet 13 is provided with a negative tab 131. Along the thickness direction D of the main body 11, the main body 11 is divided into two halves, and multiple positive tabs 121 are located in the same half of the main body 11, that is, the positive tab group 14 is connected to one half of the main body 11; multiple negative tabs 131 are located in the same half of the main body 11, that is, the negative tab group 15 is connected to one half of the main body 11. In the multiple cells 1, the cells 1 connected to the same connecting plate 5 are divided into two groups, the positive tab groups 14 on the two groups of the cells 1 are arranged along the thickness direction D, and the positive tab groups 14 on the two groups of the cells 1 are arranged far away from each other; the negative tab groups 15 on the two groups of the cells 1 are arranged along the thickness direction D, and the negative tab groups 15 on the two groups of the cells 1 are arranged far away from each other. This facilitates the bending of the positive tab groups 14 or the negative tab groups 15, and the welding of the connecting plates 5.

For example, as shown in FIG. 13, when the number of the cells 1 is two, the two cells 1 are divided into two groups, with each group containing one cell 1. The positive tab groups 14 of the two cells 1 are connected to a connecting plate 5, and the negative tab groups 15 of the two cells 1 are connected to another connecting plate 5. Specifically, the positive tab group 14 on the left cell 1 in FIG. 13 is arranged in its left half, and the positive tab group 14 on the right cell 1 in FIG. 13 is arranged in its right half, so that the positive tab groups 14 on the two cells 1 are arranged far away from each other; similarly, the negative tab group 15 on the left cell 1 is arranged in its left half, and the negative tab group 15 on the right cell 1 is arranged in its right half, so that the negative tab groups 15 on the two cells 1 are arranged far away from each other.

As shown in FIG. 15, when the number of the cells 1 is four, the four cells 1 are divided into two groups, with each group containing two cells 1. In FIG. 15, the two cells 1 on the left side are the first group, and the two cells 1 on the right side are the second group. The positive tab groups 14 of the four cells 1 are connected to a connecting plate 5, and the negative tab groups 15 of the four cells 1 are connected to another connecting plate 5. Specifically, the positive tab groups 14 on the two cells 1 of the first group are all located on the left half of the cells 1, while the positive tab groups 14 on the two cells 1 of the second group are all located on the right half of the cells 1, so that the positive tab groups 14 on the two groups of the cells 1 are arranged far away from each other; similarly, the negative tab groups 15 on the two cells 1 of the first group are all located on the left half of the cells 1, while the negative tab groups 15 on the two cells 1 of the second group are all located on the right half of the cells 1, so that the negative tab groups 15 on the two groups of the cells 1 are arranged far away from each other.

As shown in FIGS. 16a to 16c, as an embodiment, when the number of the cells 1 is two, the positive tab groups 14 are respectively connected to multiple connecting plates 5, and the connecting plates 5 connected to the positive tab groups 14 are stacked along the thickness direction of the connecting plates 5; the negative tab groups 15 are respectively connected to multiple connecting plates 5, and the connecting plates 5 connected to the negative tab groups 15 are stacked along the thickness direction of the connecting plates 5. The method of connecting the positive tab groups 14 and the negative tab groups 15 on the cells 1 to the connecting plates 5 is as follows (it should be noted that in FIGS. 16a to 16c, the left figures are three-dimensional views, and the right figures are side views of the left figures):
(1) As shown in FIGS. 16a and 16b, the positive tabs 121 of the two cells 1 are combined to form the positive tab groups 14 that are separated from each other in the thickness direction D, and the negative tabs 131 of the two cells 1 are combined to form the negative tab groups 15 that are separated from each other in the thickness direction D. The positive tab group 14 and the negative tab group 15 on one of the cells 1 are respectively welded with the connecting plates 5, and the positive tab group 14 and the negative tab group 15 on the other of the cells 1 are respectively welded with the connecting plates 5. At this time, the positive tab groups 14 and the negative tab groups 15 are in a state parallel to the cells 1.
(2) As shown in FIG. 16b, the two cells 1 are brought together in the thickness direction D. At this time, the positive tab groups 14 on the two cells 1 are in a state away from each other, and the negative tab groups 15 on the two cells 1 are in a state away from each other. Then, the positive tab groups 14 and the negative tab groups 15 on the two cells 1 are bent towards the inner sides (i.e., in the direction of being close to each other). After bending, the connecting plates 5 connected to the positive tab groups 14 of the two cells 1 are stacked from top to bottom, and the connecting plates 5 connected to the negative tab groups 15 of the two cells 1 are stacked from top to bottom. Then, the stacked connecting plates 5 are welded together, so that the connecting plates 5 are connected to each other to obtain the state shown in FIG. 16c.

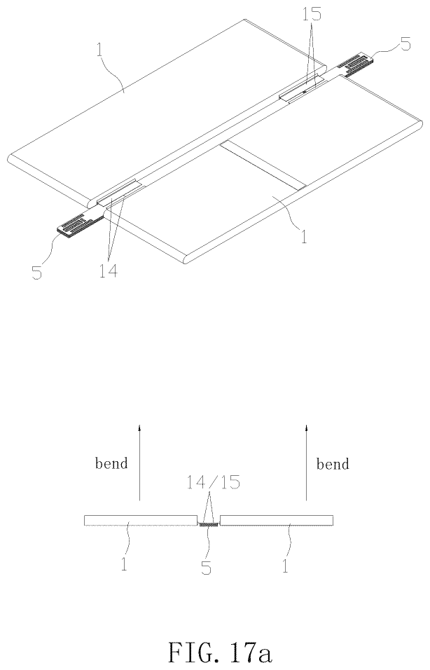

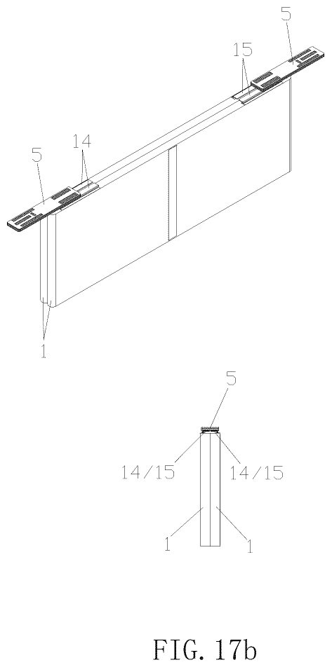

As shown in FIGS. 17a and 17b, as another embodiment, when the positive tab groups 14 of multiple cells 1 are connected to the same connecting plate 5, and the negative tab groups 15 of multiple cells 1 are connected to the same connecting plate 5, the method of connecting the positive tab groups 14 and the negative tab groups 15 on the cells 1 to the connecting plates 5 is as follows (it should be noted that in FIGS. 17a and 17b, the upper figures are three-dimensional views, and the lower figures are side views of the upper figures):
(1) As shown in FIG. 17a, the two cells 1 are deployed in a flat state, the positive tabs 121 of each cell 1 are combined to form the positive tab group 14 of the cell 1, and the negative tabs 131 of each cell 1 are combined to form the negative tab group 15 of the cell 1. The positive tab groups 14 of the two cells 1 are arranged close to each other, and the negative tab groups 15 of the two cells 1 are also arranged close to each other. The positive tab groups 14 on the two cells 1 are welded to the same connecting plate 5, and the negative tab groups 15 on the two cells 1 are welded to the same connecting plate 5.
(2) The two cells 1 are bent upwards simultaneously, so that the positive tab groups 14 and the negative tab groups 15 on the two cells 1 are bent upwards. After bending, the two cells 1 are brought to each other, resulting in the state shown in FIG. 17b.

As an embodiment, the connection position between the positive tab group 14 of the cell 1 and the connecting plate 5 is provided with an insulation adhesive (not shown); and/or, the connection position between the negative tab group 15 of the cell 1 and the connecting plate 5 is provided with an insulating adhesive.

As an embodiment, the connecting plate 5 is a single-layer or multi-layer structure.

As shown in FIG. 11, as an embodiment, an insulation sheet 6 is provided between the inner wall of the case 2 and the cell 1. The insulation sheet 6 is located on one side of the cell 1 where the tabs are located, and the insulation sheet 6 is located between the connecting plates 5 and the inner wall of the case 2.

As shown in FIG. 11, as an embodiment, the outer wall of the case 2 is further wrapped with an insulating film 7, such as a PET film.

The cell 1 provided in the embodiment of the present application has a width direction W of the main body 11 perpendicular to the plane where the winding direction S of the main body 11 is located, that is, the end faces 110 of the main body 11 are located at two ends of the main body 11 along the width direction W. Therefore, the electrolyte can enter the interior of the cell 1 from the end faces 110 at the two ends of the main body 11, that is, the electrolyte can enter the interior of the cell 1 along the width direction W of the main body 11, thereby shortening the infiltration path of the electrolyte, and improving the infiltration rate and infiltration effect of the electrolyte.

The above are only the specific embodiments of the present application, but the scope of protection of the present application is not limited to this. Any technical personnel familiar with this technical field who can easily think of changes or replacements within the scope of technology disclosed in the present application should be covered within the scope of protection of the present application. Therefore, the protection scope of the present application should be based on the protection scope of the claims.

What is claimed is:

1. A cell comprising a main body formed by winding electrode sheets and a separator, wherein the main body has a flat structure with a length direction and a width direction; a first length L1 of the main body along the length direction is greater than a first width W1 of the main body along the width direction; the width direction of the main body is perpendicular to the plane where a winding direction of the main body is located.

2. The cell as claimed in claim 1, wherein the first length L1 and the first width W1 meet the requirement: 1<L1/W1≤15.

3. The cell as claimed in claim 1, wherein the main body further has a thickness direction, and a first thickness D1 of the main body along the thickness direction and the first width W1 meet the requirement: 1<W1/D1≤50.

4. The cell as claimed in claim 1, wherein the electrode sheets comprise a positive electrode sheet and a negative electrode sheet, and the main body is formed by winding the positive electrode sheet, the negative electrode sheet and the separator; the positive electrode sheet is provided with a positive tab, and the negative electrode sheet is provided with a negative tab, wherein both the positive tab and the negative tab are located at one end of the main body along the width direction.

5. The cell as claimed in claim 4, wherein the positive tab and the negative tab are located at the same end of the main body along the width direction, and the positive tab and the negative tab are spaced from each other in the length direction of the main body.

6. The cell as claimed in claim 4, wherein the positive electrode sheet is provided with multiple positive tabs that are spaced from each other, the multiple positive tabs are located on the same side of the positive electrode sheet along the width direction, and the multiple positive tabs are stacked along the thickness direction of the main body to form a positive tab group; the negative electrode sheet is provided with multiple negative tabs that are spaced from each other, the multiple negative tabs are located on the same side of the negative electrode sheet along the width direction, and the multiple negative tabs are stacked along the thickness direction of the main body to form a negative tab group.

7. The cell as claimed in claim 6, wherein the positive tab group and the negative tab group are located at the same end of the main body along the width direction, and the positive tab group and the negative tab group are spaced from each other in the length direction of the main body.

8. The cell as claimed in claim 6, wherein along the length direction of the main body, the positive tab group has a second length L2, and the negative tab group has a third length L3;
the second length L2 and the first length L1 meet the requirement:
$$\frac{1}{20} L 1 \leq L 2 < \frac{1}{2} L 1 ;$$
the third length L3 and the first length L1 meet the requirement:
$$\frac{1}{20} L 1 \leq L 3 < \frac{1}{2} L 1.$$

9. The cell as claimed in claim 6, wherein the number of winding turns of the positive electrode sheet is a1, and the number of the positive tabs being stacked in the positive tab group is a2, then it is satisfied: 0.1a1≤a2≤2a1;
the number of winding turns of the negative electrode sheet is b1, and the number of the negative tabs being stacked in the negative tab group is b2, then it is satisfied: 0.1b1≤b2≤2b1.

10. The cell as claimed in claim 6, wherein each winding turn of the positive electrode sheet is provided with one positive tab, and each winding turn of the negative electrode sheet is provided with one negative tab;
along the thickness direction of the main body, multiple positive tabs are located on the same side of multiple winding turns of the positive electrode sheet, and multiple negative tabs are located on the same side of multiple winding turns of the negative electrode sheet.

11. The cell as claimed in claim 6, wherein each winding turn of the positive electrode sheet is provided with two positive tabs, and the two positive tabs on each winding turn of the positive electrode sheet are arranged along the thickness direction of the main body; each winding turn of the negative electrode sheet is provided with two negative tabs, and the two negative tabs on each winding turn of the negative electrode sheet are arranged along the thickness direction of the main body.

12. A prismatic battery comprising a case and the cell as claimed in claim 1, wherein the cell is disposed within the case.

13. The prismatic battery as claimed in claim 12, wherein multiple cells are disposed inside the case, and the multiple cells are arranged along the thickness direction of the main body; the prismatic battery further comprises a heat conduction member, and the heat conduction member is disposed inside the case, the heat conduction member comprises a clamping part and a contact part which are connected to each other, wherein the clamping part is clamped between adjacent cells, and the contact part is in contact with an inner wall of the case.

14. The prismatic battery as claimed in claim 12, wherein the prismatic battery further comprises a cover plate and a connecting plate; along the length direction of the main body, at least one end of the case is provided with an opening, and the cover plate is disposed at the opening; the connecting plate is disposed inside the case, and the cover plate is provided with a pole;
the electrode sheets comprise a positive electrode sheet and a negative electrode sheet, and the main body is formed by winding the positive electrode sheet, the negative electrode sheet and the separator; the positive electrode sheet is provided with multiple positive tabs, and the multiple positive tabs are stacked to form a positive tab group; the negative electrode sheet is provided with multiple negative tabs, and the multiple negative tabs are stacked to form a negative tab group; one of the positive tab group and the negative tab group on the cell is electrically connected to the pole through the connecting plate, and the other of the positive tab group and the negative tab group is electrically connected to the case; or, the positive tab group and the negative tab group on the cell are each electrically connected to the pole of a corresponding connecting plate.

15. The prismatic battery as claimed in claim 14, wherein multiple cells are disposed inside the case, and the multiple cells are arranged along the thickness direction of the main body; the positive tab groups of the multiple cells are respectively connected to multiple connecting plates, and/or the negative tab groups of the multiple cells are respectively connected to multiple connecting plates;
or, in the multiple cells, the positive tab groups of at least some of the cells are connected to the same connecting plate, and/or the negative tab groups of at least some of the cells are connected to the same connecting plate.
